(19) United States
(12) Patent Application Publication
(10) Pub. No.: US 2013/0063813 A1
(43) Pub. Date: Mar. 14, 2013

(54) Method of viewing anaglyphs with single color filter to optimize color perception

(71) Applicants: SANDEEP SOOD, TROY, MI (US); BEENA GAIND SOOD, TROY, MI (US)

(72) Inventors: SANDEEP SOOD, TROY, MI (US); BEENA GAIND SOOD, TROY, MI (US)

(21) Appl. No.: 13/229,731

(22) Filed: Sep. 11, 2011

(51) Int. Cl. G02B 27/22

(52) U.S. Cl. 359/464

(57) ABSTRACT

The present invention discloses a method of improving color quality in anaglyphs. Stereo pair images are viewed using a filter of one primary color on the side corresponding to the side of the same color primary filter used in recording the anaglyph. The other side, corresponding to the side recorded using color filter of the remaining primary colors, has only a fixed or adjustable neutral density filter that matches the luminosity to that of the one primary color filter. Retinal rivalry suppresses the one primary color image on the side of the less luminous neutral density filter image, thus generating full stereopis. Since the side with the neutral density filter perceives all of the primary colors, the color gamut is maintained.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF INVENTION

This invention relates generally to the field of stereoscopic imaging using anaglyph and specifically to full color image perception.

To develop stereoscopic perception, brain needs to have two perspectives of the object, one from the left and the other from right side referred to as a stereo pair images. This may be done using two separate cameras that provide separate side by side images and a method of blanking out alternate images from a left and right camera so the viewer sees the alternate images with a left eye followed by a right eye.

In prior art this has been achieved using anaglyphs. Anaglyphs are stereoscopic images wherein different primary colors are used to render the first and second images of the stereo pair. Usually the spectra of the first and second images do not substantially overlap each other. The first and second images may be viewed selectively using two different primary color viewing filters. The first viewing filter may be used to view the first image while the second viewing filter may be used to view the second image. The first filter substantially transmits the primary color of the first image and blocks the primary color of the second image. The second filter substantially transmits the primary color of the second image and blocks the primary color of the first image. When viewed using corresponding filters on the corresponding eyes, the respective images are fused in the mind generating stereopsis. Since image from each side is monochromatic it is converted to gray scale by the brain. As a result the final image is perceived by the brain as monochromatic or black and white.

Prior art describes a way to circumvent this deficiency in conventional two color filter anaglyphs to obtain color. Anaglyphs have been rendered in three primary colors where the first image is rendered in one primary color while the second image is rendered in two primary colors.

In red/cyan anaglyphs, the first image is rendered in a red primary color while the second image is rendered in green and blue primary colors. Other types of anaglyphs may include blue/yellow and green/magenta stereo pairs. These types of anaglyphs have two major deficiencies.

First, since the image from the single primary filter is perceived by the brain as monochromatic in grey scale, the final color gamut is limited to the other two primaries. To overcome this, two strategies have been used.

One method of improving color in three color anaglyphs is to introduce a color leak in the filters, so that some amount of the primary color wavelengths of the first filter leak through the second filter. However, transmitting of the primary colors of the opposite image through the viewing filters may cause the user to see ghost images or double images in the stereo view. The “cross talk” may reduce the ability of the user to fuse the stereo pair and may reduce the perceived stereoscopic depth in the stereo view. Therefore, when using leaky filters, the benefit of the extra hues created by the leak must be balanced against the disadvantage of perceiving less stereoscopic depth.

U.S. Pat. No. 6,687,003 describes a method of selection of filters and defines the amount of permissible leak to optimize the color gamut and minimize cross talk. The amount of permissible leak is defined as the ratio of intensity of the primary color of the first filter that passes through the second filter compared to the transmission of the most luminous color of the other two primaries through the second filter. Significant amount of post processing is required to generate these “color coded” anaglyphs. Cross talk in this method is not eliminated but can be minimized.

In US patent U.S. 2008/0278574, Ramstad describe a method to improve anaglyphs by using a filter combination in which the common wavelengths (primary subtractive colors such as cyan and yellow) are transmitted through the second filter and only the pure primary is transmitted through the first filter. For example the first filter transmits far red and the second filter transmits blue, green, yellow and orange. Alternatively, the first filter transmits strictly blue and the second filter transmits cyan, green and red. This maintains a wider color gamut but eliminates the cross talk and improves the quality of stereoscopic perception. To maintain brightness and contrast balance a complex algorithm is used for post processing the images to minimize retinal rivalry. These anaglyphs are referred to as four color anaglyphs. A deficiency of four color anaglyphs is that digital camera and recording devices work on three color systems. The fourth color is recorded as a combination of primaries in the RGB system. When played back through 3 color monitors, the information of the fourth color is displayed as a combination of the three primary colors. Hence, unless the recording and display systems have capability of using four primary colors, this is not going to be an effective strategy.

The prior art contains a method to display stereoscopic image using six primary colors with non-overlapping spectra. This method of displaying stereoscopic images has the disadvantage of the viewing filters being relatively expensive to manufacture. Also the methods of displaying stereoscopic image with the six primary colors described in the prior art produces retinal rivalry for some distribution of hues in the stereoscopic image.

Second deficiency of three color anaglyphs relates to the phenomenon of retinal rivalry. Retinal rivalry happens when a monochromatic image, such as red is presented to one eye, and a bi-chromatic image, such as cyan, is presented to the other eye. A red object is perceived in grey scale by the eye presented with the red image and as black by the eye presented with cyan image. Since cyan image is brighter, brain suppresses the red color perceived in the image presented to the other eye and the object is perceived as black instead of red. Similar, suppression occurs for blue objects in yellow-blue stereo pair anaglyphs and for green objects in green magenta stereo pairs.

The prior art lacks a working theory of how to avoid retinal rivalry when producing partial-color anaglyphs. Attempts have been made to minimize the retinal rivalry by post processing the images of each side physically or via a computer to adjust the hues and luminosity. To balance the luminosity in the two filters, U.S. Pat. No. 6,687,003 describes use of neutral density filters along with the color filters. The method suggests adding neutral density filter to the brighter of the two filters, such as cyan in red/cyan or yellow in yellow/blue stereo pairs for viewing to minimize retinal rivalry. This however makes the image darker.

Dawson in U.S. 2002/0021832 A1 describe complex computer post processing to adjust contrast and luminosity to obtain full color stereopsis.

This invention is based on the concept that retinal rivalry causes suppression of perception of the color in homologous part of image on the side on which the image is less luminous. As in the above example in red/cyan stereo pair, a red object appears dark in the cyan image (more luminous image) and red on gray scale in the red image (less luminous image). In the final perception the brain suppresses the red color in the red image (less luminous image) causing the object to appear black in the perceived final image. Reducing the luminosity of the cyan image (more luminous image) by adding a neutral density filter or by post processing the image luminosity improves the color perception by selective inhibition of the darker image.

The present invention intends on using only one primary color filter in the viewing system for anaglyphs. When a 3 color anaglyph is seen with only one primary filter on one side no stereopsis occurs. For example, if a yellow/blue anaglyph generated with a yellow filter on left side and blue filter on the right side is viewed with only a blue filter on right side no stereopsis occurs. In absence of a color filter (yellow, in this case on the left eye) the left eye sees the intended left perspective image (i.e the yellow filter image) and the right perspective image (i.e the blue filter image). The right eye however, sees the intended right perspective image (i.e the blue filter image). Since the luminosity of the entire image seen on the left eye is greater than that on the right eye, the right eye image is suppressed by the brain. Hence, the brain gets only the left perspective of the image and no stereopis is generated. However, the image contains all three primaries and hence has full gamut of colors.

The present invention intends on reducing the luminosity of the left eye image, such as in the above example, by using neutral density filter in front of the left eye to reduce the luminosity to about that of the right eye image. As a result the blue filter component of the image seen by the left eye is less luminous than the homologous image seen by the right eye. Retinal rivalry in this instance suppresses the blue component of the image in the left eye. The brain in this case then sees a full color image from the left eye and the blue filter image from the right eye but the homologous blue components of the image on the left side are suppressed for narrow parallax differences in the right and left images.

BRIEF SUMMARY OF INVENTION

Object of the invention is to improve the quality of color perception in images from anaglyphs stills, motion pictures and video.

A specific objective of the invention is to increase the color gamut by presenting one eye with a full color image containing all primaries when viewing anaglyphs generated in three or more primary colors.

A specific objective of the invention is in generating full color stereoscopic images in microscopes and endoscopes, where color perception is important and the parallax between the right and left perspective of the images is narrow.

Other aspects, features and advantages of the invention will become apparent from the following description and from the claims

### BRIEF DESCRIPTION OF SEVERAL VIEWS OF DRAWINGS

FIG. 1 shows the prior art in viewing of anaglyphs

FIG. 2 shows the setup for viewing anaglyphs using the present invention

### DETAILED DESCRIPTION OF THE INVENTION

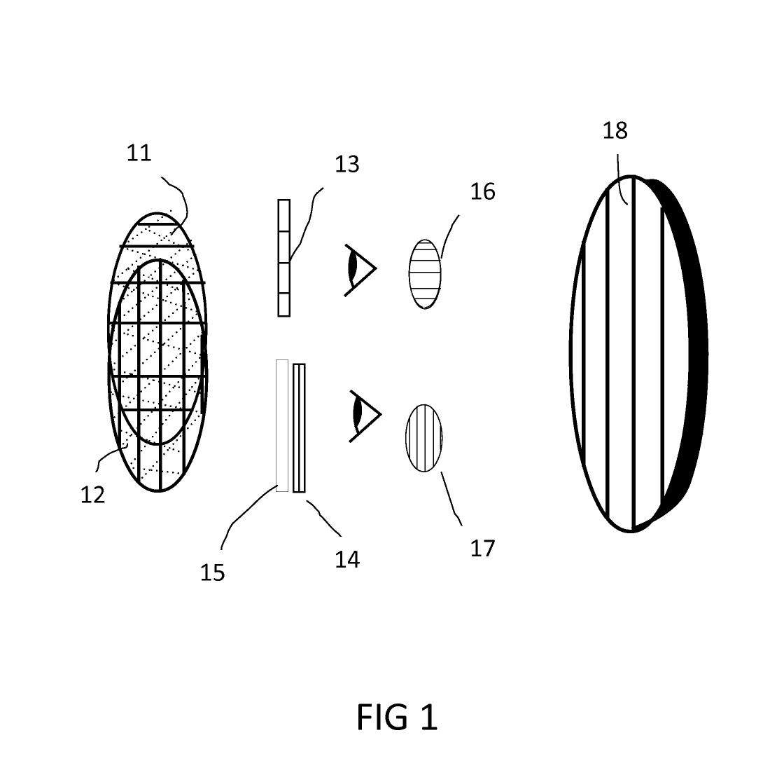

FIG. 1 illustrates the prior art in viewing of anaglyphs. Anaglyph that may have been computer processed to adjust hues, color and luminosity is presented containing image 11 representing one (right, for this example, horizontal shading) perspective of the object in one primary color, and image 12 representing the other (left, for this example, vertical shading) perspective of the object in the other two primary colors. The viewing glasses have on the corresponding side a color filter 13 of one primary color and on the other side the color filter 14 of the other two primary colors. A neutral density filter 15 is used in-addition on the side with the filter with two primary colors to balance the luminosity. In this example, the right eye sees only the image of the right perspective, 16 of the object with some permissible leak from the left image. Likewise the left eye sees only the left perspective, 17 of the object with some permissible leak from the right image. The brain integrates the two images and generates stereoscopic image 18 with partial color gamut predominantly containing the two primary colors of the left filter and a permissible leak of the third primary color from the right side.

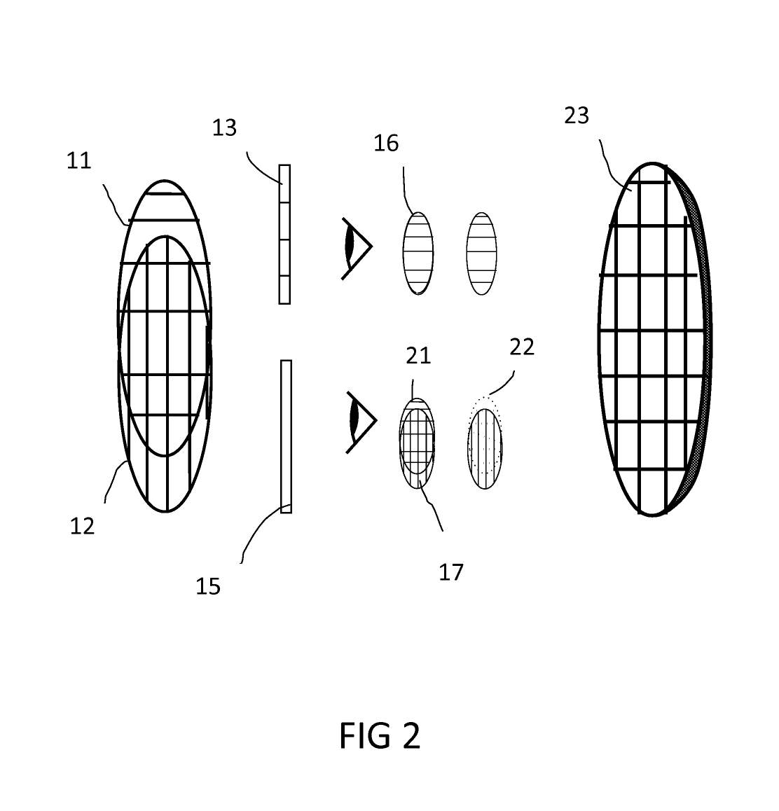

FIG. 2 shows one embodiment of the present invention. Anaglyph still, motion picture or video that may or may not have be computer processed to adjust hues, color and luminosity is presented containing image 11 representing one (right, for this example, horizontal shading) perspective of the object in one primary color, and image 12 representing the other (left, for this example, vertical shading) perspective of the object in the other two primary colors. The viewing glasses have on the corresponding side a color filter 13 of one primary color and on the other side has no color filter but just a neutral density filter 15. The neutral density filter may be a fixed value filter that matches the luminosity of the right image to that of the left image or be adjustable mechanically or optico-electronically such as with liquid crystals. In this example, the right eye sees only the image of the right perspective, 16 of the object with no leak of image from the left side. However, the left eye sees left, 17 and right, 21 perspective of the image with reduced luminosity. Retinal suppression or rivalry suppresses the right side perspective, 22 seen by the left eye in generating stereopsis, since the right side perspective 16 seen by the right eye is more luminous than the right side perspective 21 seen by the left eye. However, since all three primaries are represented in image generation, full color gamut image, 23 is perceived by the brain. In an alternative embodiment the images of right and left side may be individually presented to each eye using an optical system without departing from the scope of the present invention.

In the preferred embodiment, the observer adjusts the luminosity of the neutral density filter while looking at a color chart to optimize the color perception prior to viewing anaglyph still, motion picture or video. This may be necessary since viewing apparatus may have a different color temperature and also because the perception of color changes with age. In alternative embodiment, the observer may adjust the color temperature and color adjustment on the viewing apparatus to optimize color perception.

Other changes may be made to the embodiments shown herein without departing from the scope of the present invention which is limited only by the following claims.

We claim:

1. A method for viewing anaglyphs, wherein, the viewing system has a filter of one primary color on the side corresponding to the side of the same color primary filter used in recording the anaglyph.

2. A method for viewing anaglyphs according to claim I, wherein, the viewing system has a neutral density filter on the side corresponding to the side of the color filter of remaining primary colors used in recording the anaglyph.

3. A method for viewing anaglyphs according to claim 2, wherein, the neutral density filter may be a fixed value filter or adjustable mechanically or optico-electronically.

4. A method for viewing anaglyphs according to claim 3, wherein, the observer can adjust the luminosity of the neutral density filter by looking at a color chart to optimize color perception.

5. A method for viewing anaglyphs according to claim 2, wherein, the observer can adjust the color temperature and color on the viewing apparatus to optimize color perception
